(19) United States
(12) Patent Application Publication
(10) Pub. No.: US 2012/0099317 A1
(43) Pub. Date: Apr. 26, 2012

(54) LIGHT EMITTING DIODE LAMP

(75) Inventor: TAY-JIAN LIU, Tu-Cheng (TW)

(73) Assignee: FOXCONN TECHNOLOGY CO., LTD., Tu-Cheng (TW)

(21) Appl. No.: 13/075,186

(22) Filed: Mar. 30, 2011

(30) Foreign Application Priority Data
Oct. 20, 2010 (CN) 201010512898.2

(51) Int. Cl. F21S 4/00

(52) U.S. Cl. 362/249.02

(57) ABSTRACT

A light emitting diode lamp includes a lamp base, a number of illumination modules located on the lamp base, and at least one wire housing located on the lamp base. Each illumination module includes a module frame and a number of illumination units on the module frame. The illumination units are apart from each other. Each illumination unit includes a hollow heat dissipating assembly, at least one lighting assembly contacting the hollow heat dissipating assembly, at least one printed circuit board, and two connection units connected to two opposite terminals of the hollow heat dissipating assembly. At least one of the two connection units includes a power cord. The wire housing includes a number of first connecting terminals electrically connected to the power cords of the illumination units.

### BACKGROUND

1. Technical Field

The present disclosure relates to a light emitting diode (LED) lamp, and particularly, to an illuminating module of an LED lamp.

2. Description of Related Art

LEDs have many advantages, such as high luminosity, low operational voltage, low power consumption, easy driving, long-term reliability, environmental friendliness for not having to use mercury (Hg), and high impact resistance, which have led to LEDs being widely used as light sources.

Radiant efficiency and lifespan of the LEDs may be distinctly reduced by high working temperatures if an LED illumination device does not include a highly efficient heat dissipating assembly.

Large LED illumination devices, such as streetlights, spotlights, and searchlights, include a base, a heat dissipating assembly defining a number of fins on one side of the base, an LED light source mounted on the base opposite to the heat dissipating assembly, a housing enclosing the LED light source, and a driving power source to drive the LED light source. However, the heavy weight and huge volume of the heat dissipating assembly cause a lot of work and cost for configuration, disassembly, and repair, especially for hanging illumination devices, such as streetlights.

In addition, because of various illumination applications and customer needs, different kinds of illumination devices are designed having quite different structures, since one illumination device usually cannot be adopted to different illumination applications. As such, design, development, and manufacture of the LED illumination devices are costly.

Accordingly, it is desirable to provide an LED lamp which can overcome the described limitations.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a schematic assembled view of an LED lamp according to a first embodiment of the present disclosure.

FIG. 2 is a partially exploded view of the LED lamp of FIG. 1.

FIG. 3 shows an exploded view of an illumination unit of the LED lamp of FIG. 1.

FIG. 4 is a partial, exploded, isometric view of one terminal of a wire housing of the LED lamp of FIG. 1.

FIG. 5 is a partial, exploded, isometric view of another terminal of the wire housing of the LED lamp of FIG. 1.

FIG. 6 is a partial, assembled view of the wire housing of the LED lamp of FIG. 1.

FIG. 7 is a schematic assembled view of an LED lamp according to a second embodiment of the present disclosure.

### DETAILED DESCRIPTION

Embodiments of the disclosure are now described in detail with reference to the accompanying drawings.

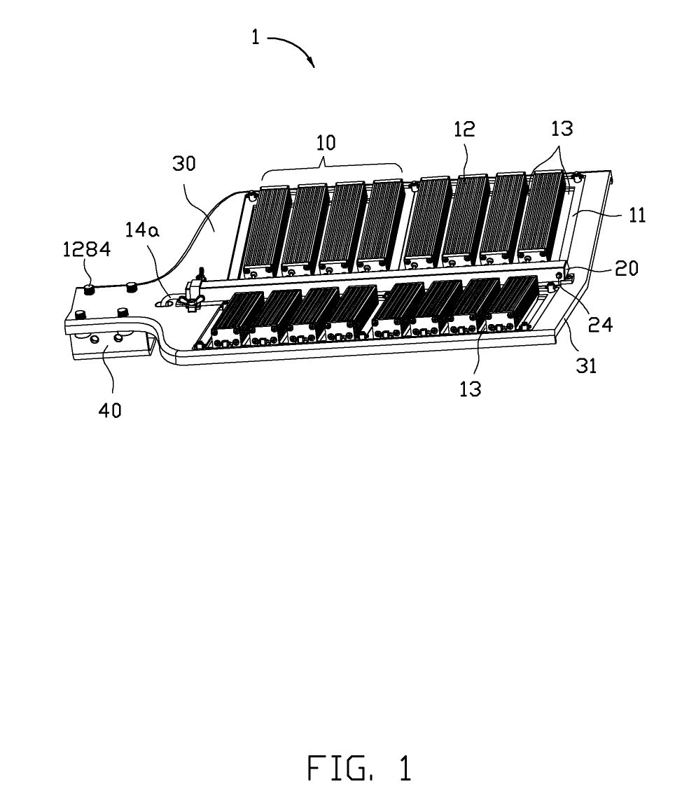

Referring to FIG. 1, the LED lamp 1 includes four illumination modules 10, a power cord 14a, a wire housing 20, a lamp base 30, and a pole connection unit 40.

The pole connection unit 40 is fixed to the lamp base 30 by four screws 1284, and can be connected to a pole or other support (not shown).

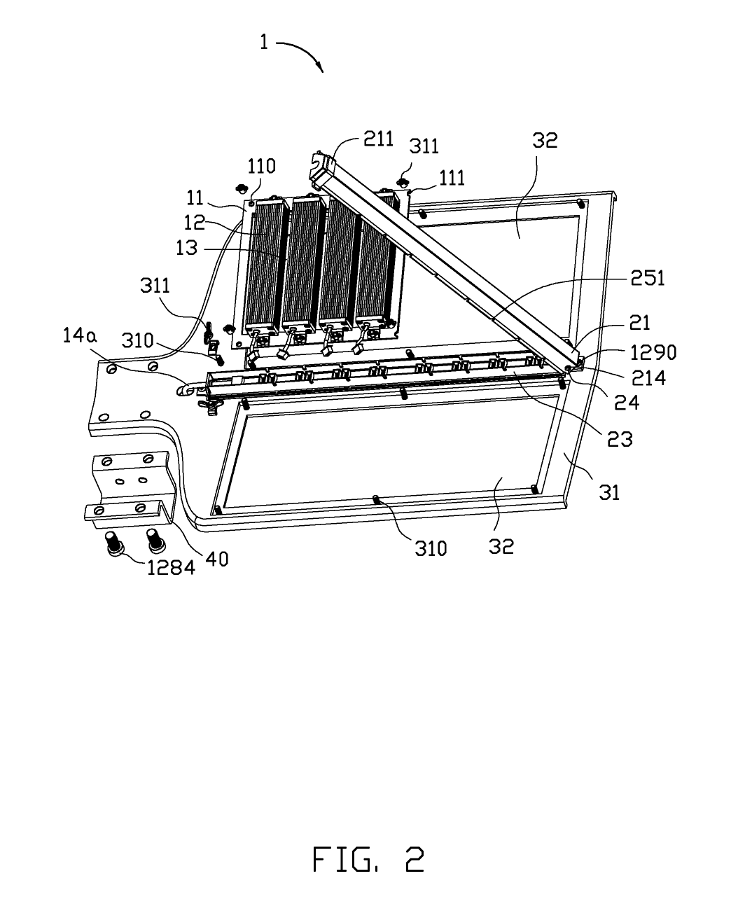

Each illumination module 10 includes a module frame 11 and four illumination units 12. Referring to FIG. 2, each module frame 11 is substantially rectangular with two screw holes 110 and two screw indents 111. Referring to both FIG. 1 and FIG. 2, the illumination units 12 are fixed on the module frame 11 by screws, and are apart from each other. There are gaps 13 between the illumination units 12 to enhance natural convection, and to reduce weight of the LED lamp 1.

The wire housing 20 is located on the lamp base 30. The wire housing 20 includes a case 23, a cap 21 corresponding to the case 23, a pivot 24 at one end of the cap 21 for rotation of the cap 21, and a fastener 211 at another end of the cap 21 to fix the cap 21. The cap 21 defines sixteen wire holes 251. The power cord 14a supplies electric power to the wire housing 20. The wire housing 20 divides the supplied electric current to the illumination units 12. When the cap 21 rotates down to close the wire housing 20, the cap 21 and the case 23 seal the wire housing 20, so the wire housing 20 is waterproof and dustproof.

The lamp base 30 includes a body 31 supporting the illuminating modules 10 and the wire housing 20. The body 31 of the lamp base 30 defines two openings 32 allowing emission of light from the illuminating module 10, and fourteen threaded bolts 310. The LED lamp 1 further includes fourteen nuts 311, such as wing nuts, corresponding to the fourteen threaded bolts 310. The body 31 is substantially symmetrical to a central line thereof, and two portions of the body 31 located on two opposite sides of the central line define an angle therebetween. As such, illumination distribution of the LED lamp 1 is broader than a planar lamp.

Each illuminating module 10 is fixed on the lamp base 30 by four of the threaded bolts 310 respectively penetrating the two screw holes 110 and the two screw indents 111 of the module frame 11, and four of the nuts 311 are respectively screwed on the four threaded bolts 310. The illumination modules 10 and the illumination units 12 can be produced in batches, and numbers and arrangements of the illumination modules 10 and the illumination units 12 can be easily adjusted. Since the LED lamp 1 is formed by the modularized illumination modules 10 and illumination units 12, the LED lamp 1 can be easily modified for various applications.

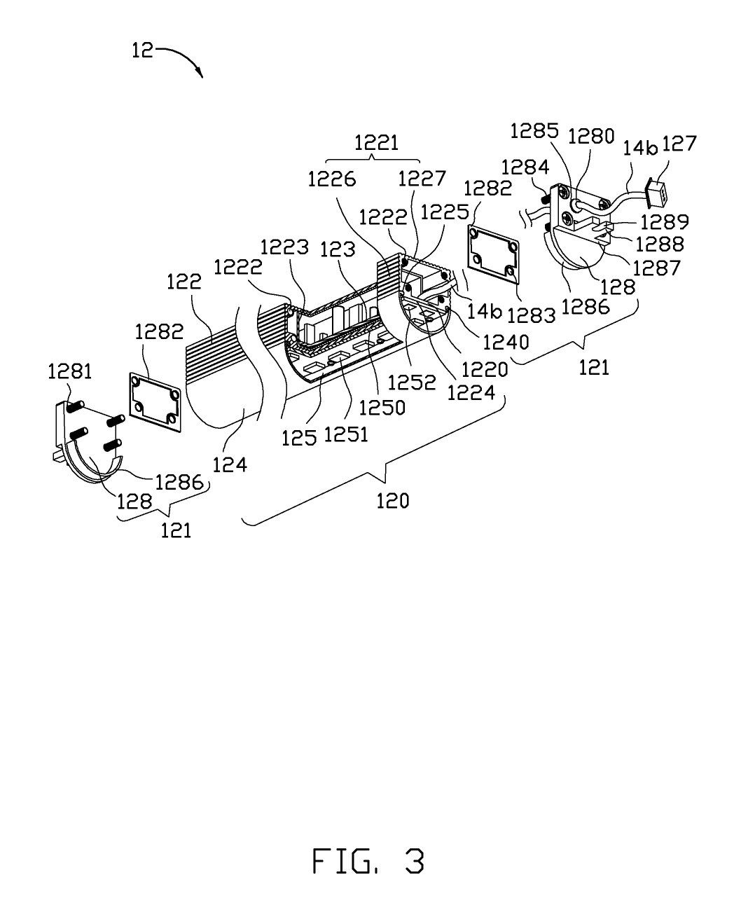

As shown in FIG. 3, each illumination unit 12 is relatively long and narrow. Each illumination unit 12 includes a long lamp module 120 and two connection units 121 connected to two opposite terminals of the lamp module 120. The lamp module 120 includes a long, hollow, heat dissipating assembly 122, at least one lighting assembly 125, at least one printed circuit board 123, and a long light guide housing 124.

The heat dissipating assembly 122 is made of thermally conductive material, such as metal. The heat dissipating assembly 122 includes a heat dissipating base 1220 and a heat dissipating case 1221, which together define a hollow rectangular space therein. Located corresponding to each of the opposite terminals of the lamp module 120, the heat dissipating case 1221 further defines four screw holes 1222 at four corners thereof. The heat dissipating assembly 122 provides protection to ensure the reliability of the illumination units 12. The metal wall of the heat dissipating assembly 122 provides electromagnetic shielding to protect the circuits and elements therein.

The heat dissipating base 1220 is substantially a plate. The outer surface of the heat dissipating base 1220 is an endothermic surface 1224 contacting the lighting assembly 125. The heat dissipating base 1220 defines two grooves 1225 respectively located on two opposite side surfaces thereof. Two terminal edges of the light guide housing 124 are received in the two grooves 1225. As such, the heat dissipating base 1220 can seal the light guide housing 124.

The heat dissipating case 1221 includes two sidewalls 1226 and a top plate 1227. The top plate 1227 is parallel to the heat dissipating base 1220, and is apart from the heat dissipating base 1220. The two sidewalls 1226 are located on two opposite edges of the top plate 1227, and extend from the top plate 1227 down to the heat dissipating base 1220. The sidewalls 1226 and the top plate 1227 include heat-dissipating structures on the outer surfaces, such as column fins shown in FIG. 3, to improve heat dissipation. It is noted that the heat-dissipating structures are not limited by the drawings, and may include any appropriate shape.

The lighting assembly 125 is located under the hollow heat dissipating assembly 122. The lighting assembly 125 includes a light source base 1250, a number of LED elements 1251 located on the light source base 1250, and a number of electrodes 1252. The electrodes 1252 are formed on a lower surface of the light source base 1250, and electrically connect the light source base 1250 to the LED elements 1251. Each LED element 1251 may include at least one LED chip sealed by a transparent material. The light source base 1250 of the lighting assembly 125 contacts the endothermic surface 1224 of the heat dissipating base 1220. The heat dissipating base 1220 may include a thermal interface material (not labeled) coated between the light source base 1250 and the endothermic surface 1224. The light source base 1250 may be tightly fixed to the heat dissipating base 1220 by screws. The heat produced from the LED elements 1251 can be effectively transferred from the lighting assembly 125 to the nearby heat dissipating case 1221.

The printed circuit board 123 is located in the hollow space defined by the heat dissipating assembly 122. The printed circuit board 123 transmits driving current to the lighting assembly 125, and controls the power supplied to the LED elements 1251. Since the hollow heat dissipating assembly 122 is made of metal in this embodiment, the lamp module 120 further includes an electrically insulative sleeve 1223 located in the hollow heat dissipating assembly 122 to surround the printed circuit board 123. The sleeve 1223 insulates the printed circuit board 123 from the hollow heat dissipating assembly 122. The sleeve 1223 can be made of thermally conductive material to enhance heat dissipation.

The light guide housing 124 is a transparent arc shaped housing covering the lighting assembly 125. The housing 124 defines two flanges 1240 respectively at two opposite edges corresponding to the two grooves 1225 of the heat dissipating base 1220. The two flanges 1240 are parallel to the extension direction of the lamp module 120. The two flanges 1240 extend inward and respectively insert into the two grooves 1225 of the heat dissipating base 1220. As such, the housing 124 is fixed to the heat dissipating base 1220. The housing 124 can adjust the illumination distribution of the LED lamp 1, and protects the lighting assembly 125. In other embodiments, each illumination unit 12 may further include lenses or reflective elements to enhance these functions.

The two connection units 121 are located at two opposite terminals of the lamp module 120, and fix the lamp module 120 to the module frame 11. Each connection unit 121 includes a cover 128, a seal piece 1282, four screws 1284, a location piece 1286, a stair portion 1287, and a protrusion piece 1288.

The location pieces 1286 are inserted into the lamp module 120 and contact the inner surface of the housing 124. Each cover 128 defines four screw holes 1281 corresponding to the four screw holes 1222. Each seal piece 1282 is located between the corresponding cover 128 and the lamp module 120. Each seal piece 1282 defines four screw holes 1283 corresponding to the four screw holes 1281 and the four screw holes 1222. For each connection unit 121, four screws 1284 penetrate the four screw holes 1281, the four screw holes 1283 and the four screw holes 1222, so the covers 128 and the seal pieces 1282 seal the heat dissipating case 1221, to make the illumination units 12 waterproof.

Each stair portion 1287 is located on the outer side of the corresponding cover 128 opposite to the lamp module 120. The stair portions 1287 can fit the edges of the opening 32 of the module frame 11 shown in FIG. 2, to position each lamp module 120. Each protrusion piece 1288 defines a hole 1289, and each illumination unit 12 is fixed to the module frame 11 by two threaded bolts 310 shown in FIG. 2 penetrating the two holes 1289, and the two nuts 311 shown in FIG. 2 respectively screwed on the two threaded bolts 310.

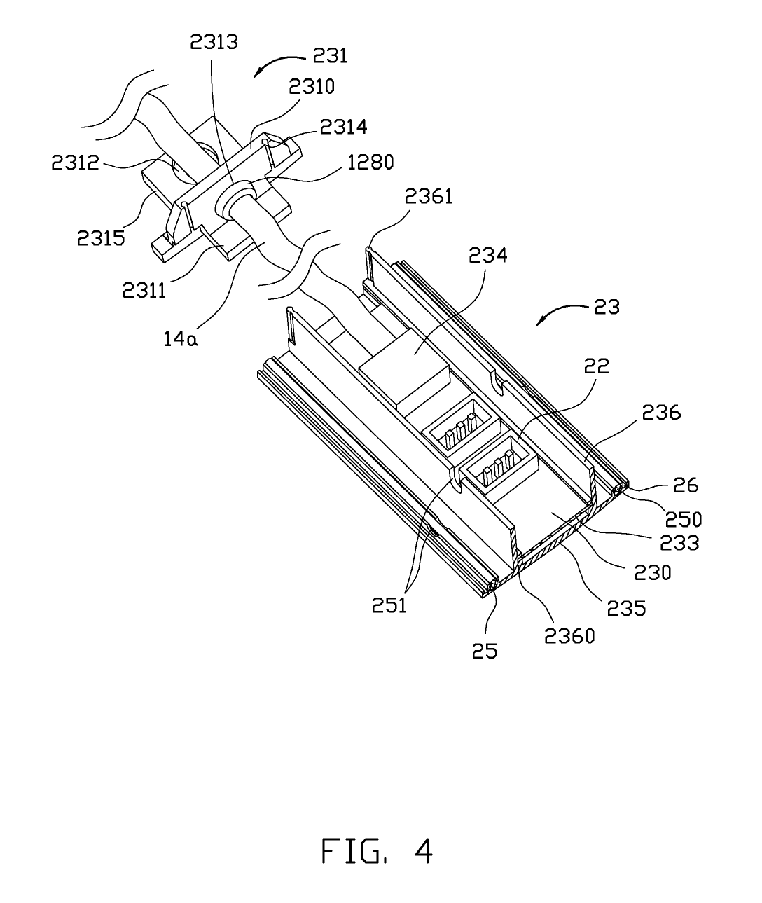

One of the connection units 121 shown in the right of FIG. 3 includes a power cord 14b and a seal ring 1280. The power cord 14b is electrically connected to the electrode (not shown) of the printed circuit board 123. The cover 128 of this connection unit 121 defines a hole 1285 to hold the power cord 14b. The seal ring 1280 is located on the outer surface of the corresponding cover 128 and surrounds the power cord 14b, to seal the lamp module 120. The power cord 14b includes a second connecting terminal 127 located outside the connection unit 121 and electrically connected to the corresponding first connecting terminal 22 of the wire housing 20 shown in FIG. 4 through the power cord 14a. Thus, electric power is supplied to the illumination unit 12.

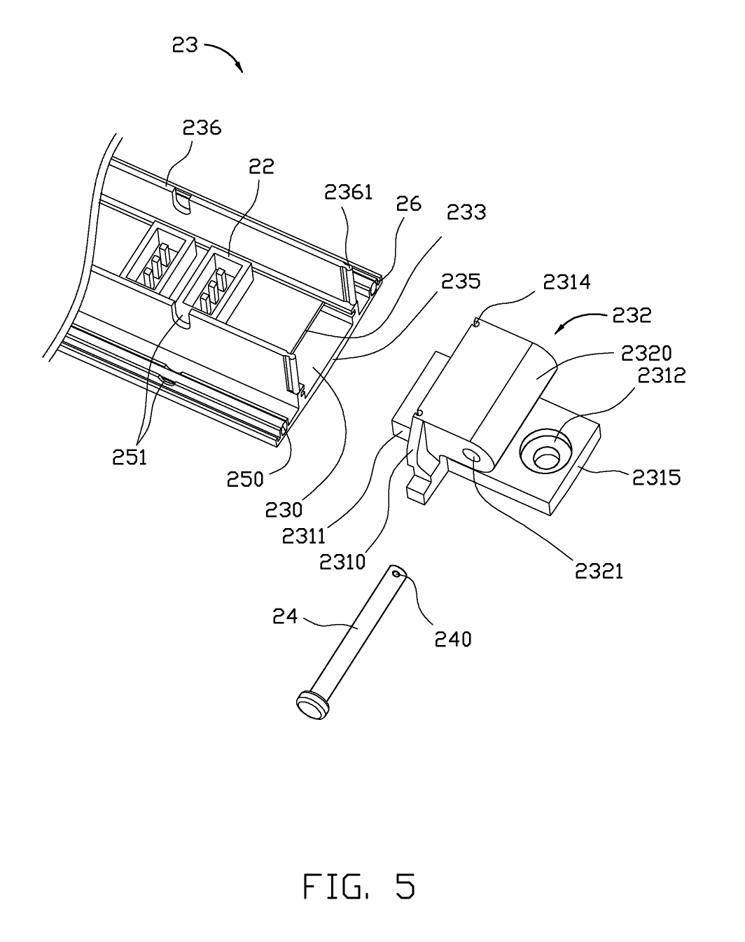

Referring to both FIG. 4 and FIG. 5, the case 23 includes a main body 230, a first fixing unit 231 shown in FIG. 4 and a second fixing unit 232 shown in FIG. 5. The first fixing unit 231 and the second fixing unit 232 are respectively located on two opposite terminals of the main body 230.

The main body 230 includes a bottom plate 235, two seal strips 250, two protrusion pieces 236, and a printed circuit board 233. The bottom plate 235 defines two track grooves 26 arranged along two long edges of the bottom plate 235, and two seal grooves 25 parallel to the track grooves 26. The two seal strips 250 are respectively located in the two seal grooves 25. The two protrusion pieces 236 are located on two opposite edges of the bottom plate 235, and extend vertically. Each protrusion piece 236 defines a long groove 2360 in the inner surface thereof, two tenon bars 2361 at two terminals thereof, and eight wire holes 251 on the upper edge thereof.

The grooves 2360 are parallel to the extension direction of the bottom plate 235, and are apart from the bottom plate 235. The grooves 2360 face each other to hold the printed circuit board 233 therebetween. Each tenon bar 2361 defines an arced portion protruding toward the nearby fixing unit 231 or 232, and a neck portion connected to the arced portion to lock the nearby fixing unit 231 or 232.

Each of the first fixing unit 231 and the second fixing unit 232 includes an end plate 2310 perpendicular to the case 23, a location portion 2311 extending from the end plate 2310 to the case 23, and a fixing portion 2315 located opposite to the location portion 2311. Each end plate 2310 defines two locking grooves 2314 corresponding to the nearby two tenon bars 2361 of the case 23. The tenon bars 2361 can slip into the locking grooves 2314 from the bottom, so that the bottom surfaces of the location portions 2311 contact the bottom plate 235 of the main body 230. Accordingly, the case 23 is locked by the first fixing unit 231 and the second fixing unit 232. Each fixing portion 2315 defines a screw hole 2312. The wire housing 20 is fixed to the lamp base 30 by two screws 1290, as shown in FIG. 2, penetrating the two screw holes 2312 and the lamp base 30.

As shown in FIG. 4, the end plate 2310 of the first fixing unit 231 further defines a wire hole 2313 to hold the power cord 14a, and the first fixing unit 231 further includes a seal ring 1280 located on the inner surface of the end plate 2310 to surround the power cord 14a.

As shown in FIG. 5, different from the first fixing unit 231, the second fixing unit 232 further includes a pivot joint portion 2320 extending from the edges of the end plate 2310. The pivot joint portion 2320 defines a pivot hole 2321. The pivot 24 penetrates the pivot hole 214 of the cap 21 shown in FIG. 2 and the pivot hole 2321 of the pivot joint portion 2320 shown in FIG. 5, so that the cap 21 is rotatably fixed to the second fixing unit 232. As such, repair or replacement of the illumination units 12 is easily performed. The pivot 24 defines a bolt hole 240, so the pivot 24 can be fixed by a bolt (not shown) penetrating the bolt hole 240.

The printed circuit board 233 includes sixteen first connecting terminals 22, a cover 234 shown in FIG. 4 and a receiving terminal (not shown) covered by the cover 234. The cover 234 is electrically isolative. The power cord 14a penetrates the case 23 through the wire hole 2313 and the seal ring 1280 and connects to the receiving terminal. Electric power is supplied from the power cord 14a to the illumination units 12 through the receiving terminal, the circuit in the printed circuit board 233, the first connecting terminals 22, the second connecting terminals 127 shown in FIG. 3, and the power cords 14b shown in FIG. 3. The wire housing 20 encloses the first connecting terminals 22 therein, and divides the supplied electric current to the sixteen first connecting terminals 22. The power cord 14a supplies electric power to the wire housing 20.

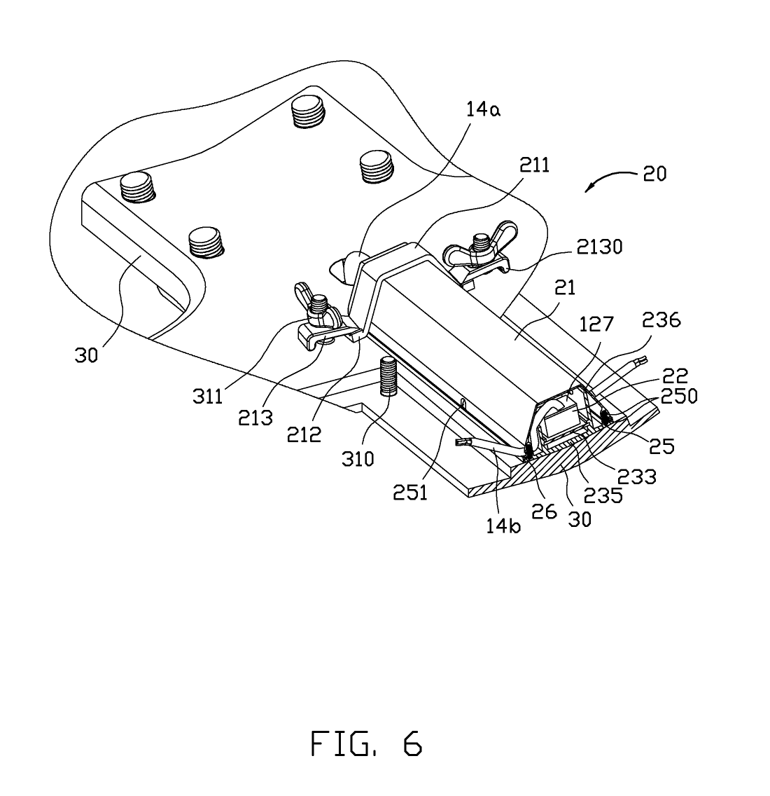

As shown in FIG. 6, the second connecting terminals 127 of the power cords 14b connect to the first connecting terminals 22. Each power cord 14b penetrates the wire holes 251 of the corresponding protrusion piece 236 and the wire holes 251 of the cap 21, and extends outwardly. The cap 21 is fixed to the lamp base 30 by two threaded bolts 310 penetrating two press pieces 213. One end 2130 of each press piece 213 contacts the lamp base 30, and another end of each press piece 213 presses the corresponding terminal 212 of the fastener 211. Two nuts 311 are respectively screwed on the two threaded bolts 310. The cap 21 further includes two seal stripes 250 in the seal grooves 25. The fastener 211 presses the cap 21 down, deforming the seal stripes 250, and the seal stripes 250 contact the power cord 14b. The edges of the cap 21 insert into the track grooves 26. Accordingly, the wire housing 20 is waterproof. Since the wire holes 251 are apart from the bottom plate 235, water is prevented from flowing into the wire housing 20. The wire housing 20 is weatherproof because the seal stripes 250 are stored in the housing 20.

Electrical connections of the present disclosure can be adjusted. For example, the first connecting terminals 22 are sockets in this embodiment, and the second connecting terminals 127 are plugs matching the first connecting terminals 22. In other embodiments, the first connecting terminals 22 can be plugs, and the second connecting terminals 127 can be sockets. In another embodiment, both the first connecting terminals 22 and the second connecting terminals 127 are located on the terminals of the illumination units 12. In other embodiments, the first connecting terminals 22 may be replaced by the second connecting terminals 127; or the second connecting terminals 127 may be replaced by the first connecting terminals 22, so the illumination units 12 includes two first connecting terminals 22 or two second connecting terminals 127 at the two terminals.

The illumination units 12 integrate optics and heat dissipation, and can operate individually. The numbers of the illumination modules 10, the wire housing 20, the lamp base 30, the module frame 11, the illumination units 12, the body 31, and the openings 32 are not limited by this embodiment, and can be adjusted as required.

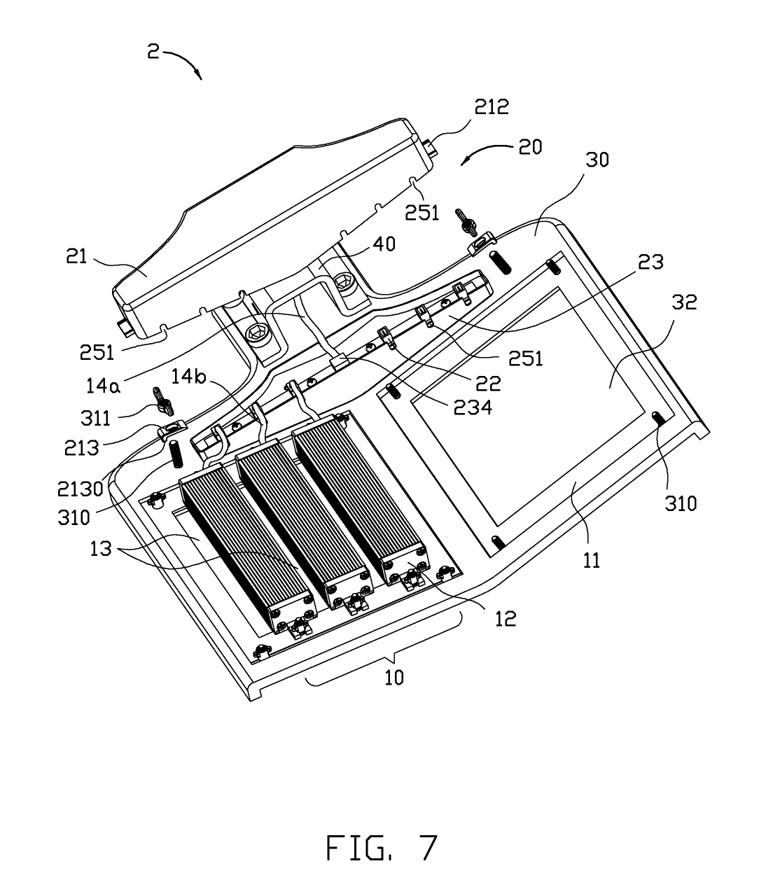

FIG. 7 illustrates an LED lamp 2 according to a second embodiment of the present disclosure. The differences between the LED lamp 1 and the LED lamp 2 are the number and direction of the illumination units 12, and the size of the module frame 11 and the electrical connections are accordingly changed. The illumination unit 12 in this embodiment is identical with the illumination unit 12 in the first embodiment, but each illumination unit 12 is parallel to the central line of the LED lamp 2 in this embodiment.

The pole connection unit 40 of the LED lamp 2 is located above the lamp base 30, on the same surface as the illumination modules 10. The wire cord 14a penetrates the space defined between the pole connection unit 40 and the lamp base 30, and directly goes into the wire housing 20. The wire housing 20 is located near the pole connection unit 40, and near the terminals of each illumination unit 12. Accordingly, the wire housing 20 is perpendicular to each illumination unit 12 and the central line of the LED lamp 2. All the wire cords 14b now penetrate the same side of the wire housing 20. The terminals 212 extend from the opposite ends of the cap 21 and are pressed by two press pieces 213.

Accordingly, the present disclosure includes the following advantages:

First, the LED lamp of the present disclosure can be easily modified because of the use of the modularized illumination units 12. The illumination units 12 integrate optics and heat dissipation, and can operate individually. The numbers, sizes, arrangements and shapes of the module frame 11 can be easily modified according to various arrangements and numbers of the illumination units 12. Thus, various applications can be easily achieved. The manufacture of the LED lamps is simplified, and the cost can be effectively reduced.

Secondly, the LED lamp of the present disclosure provides great thermal efficiency. The hollow heat dissipating assembly 122 has a large heat absorbing area and a large dissipating area, and the gaps 13 between the illumination units 12 enhance natural convection. As such, illuminating efficiency of the LED lamp is ensured, and lifetime of the LED lamp is increased.

Thirdly, the LED lamp of the present disclosure reduces the cost of disassembly and repair. The connection units 121 enable easier manual repair of the suspended LED lamp. Repairmen can quickly replace the illuminating unit 12 without tools. Accordingly, the wire housing 20 provides better safety, assembly convenience, and disassembly convenience.

Fourthly, the present disclosure provides an outdoor LED lamp with excellent weatherability. The LED lamp is protected from rain, humidity, dust, sunshine. The snow load, the drag coefficient, the amount of dust and sand deposition are reduced. Thus, safety and reliability are enhanced.

It is to be understood, however, that even though numerous characteristics and advantages of the present embodiments have been set fourth in the foregoing description, together with details of the structures and functions of the embodiments, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A light emitting diode (LED) lamp, comprising:
a lamp base, the lamp base defining at least one opening;
a plurality of illumination modules located on the lamp base, each of the plurality of illumination modules comprising:
at least one module frame corresponding to the at least one opening of the lamp base; and
a plurality of illumination units located on the module frame and apart from each other, each of the plurality of illumination units comprising:
a hollow heat dissipating assembly;
at least one lighting assembly contacting the hollow heat dissipating assembly whereby heat generated by the at least one lighting assembly is absorbed by the hollow heat dissipating assembly;
at least one printed circuit board; and
two connection units connected to two opposite terminals of the hollow heat dissipating assembly, at least one of the two connection units comprising a power cord and a seal ring surrounding the power cord; and
at least one wire housing located on the lamp base, the wire housing comprising a plurality of first connecting terminals electrically connected to the plurality of power cords of the plurality of illumination units.

2. The LED lamp of claim 1, wherein the wire housing comprises:
a case;
a cap located above the case and corresponding to the case;
a pivot penetrating one end of the cap and one end of the case for rotation of the cap; and
a fastener located at an opposite end of the cap to fix the cap.

3. The LED lamp of claim 2, further comprising:
two press pieces pressing the fastener;
two threaded bolts penetrating the two press pieces; and
two nuts respectively screwed on the two threaded bolts.

4. The LED lamp of claim 2, wherein the case of the wire housing comprises:
a bottom plate;
two protrusion pieces located on the bottom plate and perpendicular to the bottom plate; and
a printed circuit board above the bottom plate.

5. The LED lamp of claim 4, wherein the bottom plate defines:
two track grooves arranged along two long edges of the bottom plate; and
two seal grooves parallel to the track grooves, the two seal grooves being located between the two track grooves, and the two protrusion pieces being located between the two seal grooves.

6. The LED lamp of claim 5, wherein the case of the wire housing further comprises two seal strips respectively located in the two seal grooves.

7. The LED lamp of claim 4, wherein each of the two protrusion pieces defines:
a long groove located on an inner surface thereof;
two tenon bars located at two terminals thereof; and
a plurality of wire holes located on an upper edge thereof.

8. The LED lamp of claim 7, wherein the two long grooves facing each other to hold the printed circuit board therebetween.

9. The LED lamp of claim 7, wherein the two long grooves are apart from the bottom plate.

10. The LED lamp of claim 7, wherein each of the two tenon bar defines an arced portion protruding outwardly and a neck portion connecting to the arced portion.

11. The LED lamp of claim 10, wherein the case of the wire housing comprises a first fixing unit and a second fixing unit respectively located on two opposite terminals of the bottom plate.

12. The LED lamp of claim 11, wherein each of the first fixing unit and the second fixing unit comprises:
an end plate perpendicular to the bottom plate;
a location portion extending from the end plate toward the bottom plate, and
a fixing portion located opposite to the location portion.

13. The LED lamp of claim 12, wherein each of the end plates defines two locking grooves corresponding to two of the four tenon bars.

14. The LED lamp of claim 13, wherein the four tenon bars slip into the four locking grooves from bottoms of the four locking grooves, so bottom surfaces of the two location portions contact the bottom plate.

15. The LED lamp of claim 1, wherein each of the plurality of illumination units further comprises a light guide housing.

16. The LED lamp of claim 15, wherein the hollow heat dissipating assembly comprises a heat dissipating base and a heat dissipating case, which together define a hollow space therein.

17. The LED lamp of claim 16, wherein the heat dissipating base defines two grooves respectively located on two opposite side surfaces thereof.

18. The LED lamp of claim 17, wherein two terminal edges of the light guide housing are received in the two grooves of the heat dissipating base.

19. The LED lamp of claim 18, wherein each of the two connection units comprises:
a cover;
a seal piece located between the cover and the hollow heat dissipating assembly;
a location piece contact an inner surface of the light guide housing; and
a stair portion located on the outer side of the corresponding cover opposite to the hollow heat dissipating assembly.

20. The LED lamp of claim 2, wherein another one of the two connection units comprising a pivot joint portion extending from the corresponding end plate, and the pivot penetrates the cap and the pivot joint portion.
